(19) United States
(12) Patent Application Publication
(10) Pub. No.: US 2026/0262670 A1
(43) Pub. Date: Sep. 10, 2026

(54) CREAMER COMPOSITION

(71) Applicant: SOCIETE DES PRODUITS NESTLE S.A., Vevey (CH)

(72) Inventors: OLIVIER YVES ROGER, Moudon (CH); KORINA TERRAZAS VELARDE, Konolfingen (CH); PHILIPPE ROUSSET, Echallens (CH); CHRYSTEL LORET, Lausanne (CH)

(21) Appl. No.: 18/847,488

(22) PCT Filed: Mar. 9, 2023
(86) PCT No.: PCT/EP2023/055966

§ 371 Date: Sep. 16, 2024

(30) Foreign Application Priority Data
Mar. 18, 2022 (SG) 10202202798S
May 30, 2022 (EP) 22176092.9

(51) Int. Cl. A23C 11/06

(52) U.S. Cl. CPC A23C 11/06

(57) ABSTRACT

The present invention relates to a creamer composition, particularly a creamer comprising hydrolysed barley and a method of producing the creamer.

### FIELD OF THE INVENTION

The present invention relates to a creamer composition, particularly a creamer comprising hydrolysed barley and a method of producing the creamer.

### BACKGROUND OF THE INVENTION

Beverage creamers are added to beverages such as coffee and tea. Many creamers contain high amounts of sugar, often in the form of glucose syrup (sometimes known as starch syrup). Glucose syrup may be undesirable for nutritional reasons, and to increase the nutritional profile there is a desire to replace glucose syrup with components with a better nutritional profile while retaining taste, aroma, texture and other characteristics.

Beverage creamers may for example be in powdered form, and glucose syrup may contribute to the volume of the powder as well as the mouthfeel obtained when adding the powdered creamer to a beverage. Furthermore, powdered beverage creamers are usually produced by drying a liquid emulsion comprising the components of the creamer product. It is important that the liquid composition can be dried in an efficient way resulting in a free-flowing powder that is easily dissolved when added to the intended beverage.

There is a desire to completely or in part replace glucose syrup and improve the nutritional profile of such creamers and therefore a need for food and beverage ingredients that can replace glucose syrup while maintaining sweetness, volume, efficient drying and final powder properties and improve the nutritional profile. Synthetic sweeteners, often added in very small amount, can contribute sweetness but may lead to lower product volume as well as different texture and process characteristics of the products.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

### SUMMARY OF THE INVENTION

An object of the present invention is to improve the state of the art and to provide an improved solution to overcome at least some of the inconveniences described above or at least to provide a useful alternative.

The object of the present invention is achieved by the subject matter of the independent claims. The dependent claims further develop the idea of the present invention.

The inventors have surprisingly found that a powdered creamer which is stable when added to a beverage and with good sensorial properties and whitening capacity can be obtained by replacing glucose syrup with hydrolysed barley. Accordingly, the present invention provides in a first aspect a creamer composition comprising; 10 to 55 wt. % of vegetable oil and/or milk fat; 0.1 to 4 wt. % of buffering agent; and 15 to 70 wt. % of hydrolysed barley solids; wherein the total amount of maltose is between 2% and 12% by weight of the creamer composition, and the total amount of maltotriose is between 2% and 12% by weight of the creamer composition, all weight percentages being expressed on a dry basis.

In a second aspect, the invention is to a method of producing the creamer composition of the invention comprising; a) suspending barley in an aqueous liquid to produce a slurry; b) hydrolysing the slurry of step a) with alpha-amylase; c) removing particulates from the slurry after performing step b) to obtain a wort; and d) combining the wort obtained in step c) with buffering agent, vegetable oil and/or milk fat to obtain a creamer.

### BRIEF DESCRIPTION OF THE DRAWINGS

FIG. 1 shows a plot of concentrate viscosity in mPa·s at 70° C. (y-axis) against shear rate in s⁻¹ (x-axis) for a creamer concentrate of the invention (A) and a reference creamer concentrate made with glucose syrup (Ref).

### DETAILED DESCRIPTION OF THE INVENTION

Consequently the present invention relates in part to a creamer composition comprising; 10 to 55 wt. % (for example 25 to 55 wt. %, for further example 25 to 40 wt. %) of vegetable oil and/or milk fat; 0.1 to 4 wt. % of buffering agent; and 15 to 70 wt. % of hydrolysed barley solids; wherein the total amount of maltose is between 2% and 12% by weight of the creamer composition, and the total amount of maltotriose is between 2% and 12% by weight of the creamer composition, all weight percentages being expressed on a dry basis.

In the present description, all weight percentages are given on a dry weight basis unless otherwise indicated.

By a creamer composition is meant a composition intended to be added to a beverage or liquid food product, such as e.g. coffee, tea, bouillon and/or soup, and is usually used to impart colour, e.g. whitening, texture, taste and/or aroma to the beverage or liquid food product. Creamers are widely used as whitening agents and texture/mouthfeel modifiers for hot and cold beverages, e.g., coffee, cocoa, tea, etc. They are commonly used as an alternative to milk or dairy cream. Creamers may come in a variety of different flavours and provide a whitening effect, mouthfeel, body, a smoother texture, taste and/or aroma and may be in powdered or liquid form.

The creamer composition may be a beverage creamer composition. There are three main types of beverage creamers; so-called “non-dairy” creamers, filled dairy creamers and plant-based or vegan creamers. The creamer composition according to the invention may be in the form of a powder or a liquid.

Vegetable oil according to the invention may be any oil suitable for human consumption derived from plant or algal material. The vegetable oil may be selected from the group consisting of coconut oil, soy bean oil, rapeseed oil, sunflower oil, canola oil, safflower oil, palm oil, palm kernel oil, algal oil, cotton seed oil, corn oil, olive oil and combinations of these. Preferred vegetable oils are coconut oil, palm kernel oil or oleins, soy oil, e.g. high oleic-low linolenic soy oil, sunflower oil, e.g. high oleic sunflower oil, algal oil, rice bran oil, almond oil, oil from nuts, canola oil, safflower oil, cotton seed oil, and corn oil and any combination thereof, as a blend or interesterified. The oil may be in hydrogenated form or in non-hydrogenated form. The vegetable oil may be in any suitable form, e.g. in a purified form as oil, or it may be in the form of plant ingredients comprising oil as well as other compounds such as carbohydrate and/or protein, e.g. in the form of flour such as rice flour, corn flour, tapioca flour or oat flour, or crushed or milled plant parts, e.g. nuts, almonds, soy beans, oat, quinoa, hemp and pea and any combinations thereof. The vegetable oil may be present in the creamer composition in an amount of 10-55 wt. %, for example 12-50 wt. %, for example 20-45 wt. %, for further example 25-40 wt. %.

Buffering agents prevent undesired creaming or precipitation of the creamer upon addition into a hot, acidic environment such as coffee. The buffering agent can for example be monophosphates, diphosphates, sodium mono- and bicarbonates, potassium mono- and bicarbonates, or a combination thereof. Preferred buffers are salts such as potassium phosphate, dipotassium phosphate, potassium hydrophosphate, sodium bicarbonate, sodium citrate, sodium phosphate, disodium phosphate, sodium hydrophosphate, citric acid and sodium tripolyphosphate. The buffering agent may for example be present in an amount of about 0.2 to about 3% by weight of dry matter of the creamer.

The buffering agent may comprise 0.5 to 2.5 wt. % of sodium bicarbonate, the buffering agent may comprise 0.4 to 1.5 wt. % of citric acid. For example the buffering agent may comprise 0.5 to 2.5 wt. % of sodium bicarbonate and 0.4 to 1.5 wt. % of citric acid. The sodium bicarbonate may be in the form of baking soda. The citric acid may be provided in the form of citrus juice, for example lemon juice.

By hydrolysed barley solids is meant barley that has been subjected to enzymatic hydrolysis by carbohydrate degrading enzymes, for example alpha-amylase. The hydrolysis may be performed by the use of purified enzymes and/or enzyme preparations, or it may be performed using the endogenous enzymes of barley malt, e.g. as in a conventional mashing process, or it may be a combination of using endogenous and added enzymes. Enzyme preparations to be used may e.g. comprise alpha-amylase, cellulase, xylanase, beta-glucanase, pullulanase, proteinase and/or lipase. An example of a suitable commercially available enzyme preparation is Ondea® Pro A (Novozymes A/S, Denmark).

The creamer composition of the invention may comprise between 40 and 70 wt. % hydrolysed barley solids. The creamer composition of the invention may comprise between 15 and 25 wt. % hydrolysed barley solids. The creamer composition of the invention may comprise maltose at a total amount between 6 and 12% by weight. The creamer composition of the invention may comprise maltotriose at a total amount between 6 and 12% by weight. The creamer composition of the invention may comprise maltose at a total amount between 2 and 4% by weight. The creamer composition of the invention may comprise maltotriose at a total amount between 2 and 4% by weight. Maltose is a disaccharide consisting of two glucose molecules linked with α-1,4 glycosidic bonds. Maltotriose is a trisaccharide consisting of three glucose molecules linked with α-1,4 glycosidic bonds.

The creamer of the invention may be a so-called “non-dairy creamer”. Such creamers do not contain milk per se, but typically contain caseinate, for example caseinate salts. In an embodiment, the creamer composition of the invention comprises 1 to 6 wt. % caseinate on a dry basis, for example caseinate in the form of caseinate salts such as sodium caseinate or calcium caseinate.

The creamer composition may comprise milk fat, for example between 5 and 30 wt. % milk fat. The milk fat may be added as such, or may be part of another ingredient such as milk powder.

In an embodiment the creamer composition comprises 15 to 30 wt. % of non-fat milk solids.

The creamer composition of the invention may be a filled-dairy creamer. Filled-dairy products contain milk components which have been blended or compounded with fat or oil other than milk fat.

The creamer composition of the invention may be a vegan creamer, comprising no ingredients from animal origin. In an embodiment the creamer composition further comprises 0.5 to 8 wt. % plant protein, for example 1.5 to 6 wt. % plant protein, for example 2 to 4 wt. % plant protein. Plant protein according to the invention may be any protein suitable for human consumption derived from plant material. Preferred plant proteins are soy protein, rice protein, pea protein, chickpea protein, potato protein, canola protein, hemp protein, oat protein, flaxseed protein, faba bean protein, lentil protein, and combinations thereof. The protein may be hydrolysed. The protein may be in any suitable form, e.g. in a purified form, e.g. as protein isolate or protein powder, or it may be in the form of plant ingredients comprising protein as well as other compounds such as carbohydrate and/or oil, e.g. in the form of flour such as rice flour, corn flour, tapioca flour or oat flour, or crushed or milled plant parts, e.g. nuts, almonds, soy beans, oat, quinoa, hemp and pea and any combinations thereof.

The creamer composition of the invention may comprise isomatooligosaccharides, which are a class of short chain carbohydrates of which some are resistant towards digestion in the human intestines and may have prebiotic effects and low glycemic index. In an embodiment the creamer composition comprises isomaltose, isomaltotriose and panose at a total amount of between 0.1 wt. % and 5 wt. %, for example between 0.5 and 2 wt. %.

The creamer composition of the invention may further comprise one or more emulsifiers. The emulsifier may for example be selected from the group consisting of monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides, lecithins, lysolecithins, succinic acid esters of mono- and/or diglycerides, lactic acid esters of mono- and/or diglycerides, lecithins, lysolecithins, proteins and sucrose esters of fatty acids, lecithin (e.g. soy lecithin, canola lecithin, sunflower lecithin, and/or safflower lecithin), lysolecithins and combinations thereof. The emulsifiers may be present at between 0.1 and 1.5 wt. %, for example between 0.2 and 0.8 wt. %. The emulsifier may be lecithin.

The creamer composition may comprise a hydrocolloid. Hydrocolloids may help to improve physical stability of the composition. Suitable hydrocolloids may e.g. be carrageenan, such as kappa-carragenan, iota-carragenan, and/or lambda-carragenan; starch, e.g. modified starch; cellulose, e.g. microcrystalline cellulose, methyl cellulose, or carboxy-methyl cellulose; agar-agar; gelatine; gellan (e.g., high acyl, low acyl); guar gum; gum Arabic; kojac; locust bean gum; pectin; sodium alginate; maltodextrin; tracaganth; xanthan; or a combination thereof. The hydrocolloid may be present at a level of between 0.1 and 5 wt., for example between 0.5 and 3 wt. %.

The creamer composition may comprise a whitener, for example calcium carbonate. The whitener may be present at between 1 and 6 wt. %.

The creamer composition may be in the form of a powder, for example a spray dried powder, a roller dried powder, a freeze dried powder, an agglomerated powder, or any other suitable from of powder or combination thereof. In an embodiment, the creamer composition according to the invention is in the form of a spray dried powder. The creamer may be mixed with other ingredients, for example the creamer may be combined with soluble coffee and foaming agents to form a foaming coffee mix.

In a further aspect, the invention relates to a method of producing the creamer composition of the invention comprising;
a) suspending barley (for example green barley) in an aqueous liquid to produce a slurry;
b) hydrolysing the slurry of step a) with alpha-amylase;
c) removing particulates from the slurry after performing step b) to obtain a wort; and
d) combining the wort obtained in step c) with buffering agent, vegetable oil and/or milk fat to obtain a creamer.

Barley to be used in the method of the invention may for example be in the form of green barley and/or barley malt. The green barley or barley malt may be treated in any suitable way to facilitate the hydrolysis, usually it will be crushed or ground to increase the surface area and facilitate the access of the alpha-amylase to the substrate. The barley to be hydrolysed may be combined with one or more adjuncts such as e.g. starches of tapioca, cassava, maize or rice, the slurry to be hydrolysed by alpha-amylase may e.g. comprise 30-70% by dry weight of adjunct, e.g. 30-70% of tapioca starch.

The slurry of barley is hydrolysed with alpha-amylase. The hydrolysis of the barley slurry may be performed by adding alpha-amylase to the slurry, e.g. in the form of pure alpha-amylase or in the form of an enzyme preparation comprising alpha-amylase. It may also be performed by using barley malt for the slurry. Barley malt contains endogenous alpha-amylase, as well as other carbohydrate degrading enzymes, which catalyse the hydrolysis of the carbohydrates of the barley malt in the slurry. The hydrolysis transforms starch contained in the barley into lower molecular carbohydrates and sugars, such as e.g. glucose, fructose, maltose and maltotriose.

If alpha-amylase is added as an enzyme preparation, the enzyme preparation may comprise further enzyme activities, e.g. cellulase, xylanase, beta-glucanase, pullulanase, proteinase and/or lipase. The pH of the barley may be adjusted before the contacting with an enzyme preparation comprising alpha-amylase, the pH may for example be lowered, e.g. to a pH in the range of pH 4.8-5.1. pH adjustment may be performed in any suitable way, e.g. by addition of a base, e.g. sodium hydroxide, and/or calcium chloride.

Barley malt is barley grain that has undergone a germination step wherein endogenous enzymes, including alpha-amylase, have been formed. These enzymes are able to degrade high molecular weight substances such as starch, protein and fat into low molecular substances such as sugars, mainly comprising glucose, fructose, maltose and maltotriose, amino acids and fatty acids. If barley malt is used, it may be treated in any suitable way to induce the hydrolysis. Hydrolysis of barley malt, also known as “mashing” is a well-known process e.g. used in brewing and production of malt extract.

In an embodiment the hydrolysis of the slurry with alpha-amylase is performed at between 45 and 80° C. (for example between 5° and 60° C.) for a time sufficient to permit hydrolysis, for example between 15 and 90 minutes (for example between 20 and 60 minutes).

Particulates such as spent grain are removed from the slurry to produce a wort. The particulates may be removed by any suitable method, e.g. by filtration or centrifugation. The wort may be concentrated, e.g. by evaporation and/or filtration, and may additionally be dried, e.g. by spray drying or roller drying.

The wort is combined with buffering agent, vegetable oil and/or milk fat to obtain a creamer. Mixing of components may be achieved by any suitable way known in the art. For example, oil may be mixed into an aqueous suspension of one or more buffering salts together with other optional ingredients such as one of more emulsifiers, one or more buffering salts, one or more hydrocolloids and/or one or more proteins, to produce an emulsion of oil in water.

If the final product is a liquid creamer, the water content of the final mixture may be adjusted to achieve the final desired solids content in any suitable way, e.g. by addition or removal of water. The product may be heat treated to improve shelf stability, e.g. by pasteurisation, UHT treatment, or sterilisation, and packed in suitable containers.

If the final product is a creamer powder, the ingredients may for example be in powder form and mixed in the dry state, some or all ingredients may be mixed in aqueous solution/suspension and subsequently dried to a powder, or some or all powdered ingredients may e.g. be co-agglomerated to produce a powder with improved solubility. The ingredients may be homogenized and heat-treated before being dried (for example spray-dried).

In an embodiment, the hydrolysis in step b) is performed in the presence of one or more further enzymes selected from the group consisting of cellulase, xylanase, beta-glucanase, pullulanase, proteinase and lipase.

By alpha-amylase is understood one or more enzymes with enzymatic activity of enzyme class EC 3.2.1.1, which catalyses the endohydrolysis of (1->4)-alpha-D-glucosidic linkages in polysaccharides containing three or more (1->4)-alpha-linked D-glucose units. An alpha-amylase according to the invention may have only alpha-amylase activity or may additionally possess one or more side activities. EC (Enzyme Committee) numbers refer to the definition of enzymatic activity and nomenclature given by the Nomenclature Committee of the International Union of Biochemistry and Molecular Biology.

By xylanase is understood an enzyme with enzymatic activity of enzyme class EC 3.2.1.8, also called endo-1,4-beta-xylanase, which catalyses the endohydrolysis of (1->4)-beta-D-xylosidic linkages in xylans. A xylanase may have only xylanase activity or may additionally have one or more side activities, i.e. other enzymatic activities in addition to xylanase activity.

By cellulase is understood an enzyme with enzymatic activity of enzyme class EC 3.2.1.4 which catalyses the endohydrolysis of (1->4)-beta-D-glucosidic linkages in cellulose, lichenin and cereal beta-D-glucans and may also hydrolyze 1,4-linkages in beta-D-glucans also containing 1,3-linkages. A cellulase may have only cellulase activity or may additionally have one or more side activities, i.e. other enzymatic activities in addition to cellulase activity.

By beta-glucanase is understood an enzyme with enzymatic activity of enzyme class EC 3.2.1.6, also called endo-1,3(4)-beta-glucanase, which catalyses the endohydrolysis of (1->3)- or (1->4)-linkages in beta-D-glucans when the glucose residue whose reducing group is involved in the linkage to be hydrolyzed is itself substituted at C-3.

By endoprotease, also called endopeptidase, is meant a protease that break peptide bonds of nonterminal amino acids (i.e. within the molecule), in contrast to exopeptidases, which break peptide bonds from end-pieces of terminal amino acids.

The enzymes may be derived from any suitable source. They may e.g. be in the form of an extract of microbial cells comprising the desired enzymatic activities, or they may for example be in the form of a mixture of extracts of two or more different microbial cells. Cell extracts may have undergone purification to remove undesired components, e.g. undesired enzymatic activities, and/or to increase the concentration of desired enzymes.

In an embodiment, transglucosidase is added to the hydrolysed slurry of step b) or the wort of step c) and allowed to act. Transglucosidase catalyses the production of isomaltooligosaccharides and glucose. This is beneficial as isomatooligosaccharides are a class of short chain carbohydrates of which some are resistant towards digestion in the human intestines and may have prebiotic effects and low glycemic index. Any suitable transglucosidase may be used such as for example a transglucosidase from Aspergillus niger such as e.g. Transglucosidase L “Amano” (Amano Enzyme Inc., Japan). The addition may be performed at any suitable temperature and for any suitable time, taking the characteristics of the transglucosidase into consideration. The addition to the slurry of transglucosidase may be performed 10-60 minutes after the start of the hydrolysis with alpha-amylase.

By transglucosidase is understood one or more enzymes with enzymatic activity of enzyme class EC 3.2.1.20, also called alpha-glucosidase, which catalyses the hydrolysis of terminal, non-reducing (1->4)-linked alpha-D-glucose residues with release of alpha-D-glucose. A transglucosidase according to the invention may have only transglucosidase activity or may additionally possess one or more side activities. Especially, a transglucosidase of the invention may have activity of enzyme class EC 2.4.1.24 and catalyse the transfer of an alpha-D-glucosyl residue in a (1->4)-alpha-D-glucan to the primary hydroxy group of glucose, free or combined in a (1->4)-alpha-D-glucan, e.g. producing isomaltose from D-glucose, and panose from maltose. In a preferred embodiment of the invention, a transglucosidase has activity of both enzyme class EC 3.2.1.20 and enzyme class EC 2.4.1.24.

After the hydrolysis of the slurry with alpha-amylase and the optional action of transglucosidase has progressed to the desired degree, the enzymatic reactions may be stopped, e.g. by inactivating the enzymes. In an embodiment, the temperature of the slurry is increased to between 7° and 95° C. to inactivate the enzymes, for example between 86 and 92° C.

In an embodiment, transglucosidase is not used, for example no transglucosidase is added to the hydrolysed slurry of step b). If transglucosidase is not used, the creamer composition will have a low levels of isomaltooligosaccharides such as isomaltotriose and panose. In an embodiment, the creamer composition has less than 2% by weight isomaltotriose, for example less than 1% isomaltotriose. In an embodiment, the creamer composition has less than 2% by weight of isomaltose, isomaltotriose and panose.

In an embodiment, a starch hydrolysate adjunct is added to the wort produced in step c). The starch hydrolysate adjunct may be the hydrolysis product of a starch-containing substrate selected from the group consisting of tapioca, oats, corn, rice, wheat, maize, rye, sorghum, triticale, sesame, quinoa, buckwheat, spelt, amaranth, pearl millet and combinations of these. For example the starch hydrolysate adjunct may be hydrolysed tapioca, cassava, maize or rice. The starch-containing substrate may be hydrolysed using alpha-amylase. The starch hydrolysate adjunct may be added to the wort at a ratio of between 1:0.4 to 1:2.5 adjunct to wort on a solids weight basis.

In an embodiment, the wort produced in step c) optionally containing starch hydrolysate adjunct, is evaporated to a total solids between 70% and 90% before being combined in step d).

In an embodiment the wort and optional starch hydrolysate adjunct constitute between 15 and 70% by weight of the dry solids of the creamer obtained in step d).

Those skilled in the art will understand that they can freely combine all features of the present invention disclosed herein. In particular, features described for the product of the present invention may be combined with the method of the present invention and vice versa. Further, features described for different embodiments of the present invention may be combined. Where known equivalents exist to specific features, such equivalents are incorporated as if specifically referred to in this specification.

Further advantages and features of the present invention are apparent from the figures and non-limiting examples.

### EXAMPLES

### Example 1

A slurry of barley grist in water was prepared and heated to 45-60° C. and an enzyme preparation (Ondea® Pro A, Novozymes A/S, Denmark) comprising alpha-amylase, pullulanase, cellulase, xylanase, protease and lipase was added and allowed to react. The temperature was then raised to 90° C. to inactivate the enzymes, and the slurry was filtered through a filter press to remove the spent grain and produce a wort. The wort was mixed with the same weight of hydrolysed tapioca starch.

The wort was used to produce a creamer with the composition given in the table below. The vegetable oil and lecithin were emulsified into an aqueous mixture of sodium caseinate citric acid and sodium bicarbonate to which the wort and hydrolysed tapioca starch were added. The creamer was homogenized to form a creamer concentrate before being spray dried to form a creamer powder.

A reference creamer was produced in the same way and with the same composition, except that glucose syrup was used instead of the mixture of wort and hydrolysed tapioca starch.

| | A: Creamer with | Ref: Reference creamer |
|---|---|---|
| % Dry matter in creamer | hydrolysed barley | with glucose syrup. |
| Glucose syrup (32 DE) | — | 65 |
| Barley wort + hydrolysed | 65 | — |
| tapioca starch | | |
| Vegetable oil | 30 | 30 |
| Sunflower lecithin | 0.8 | 0.8 |
| Sodium caseinate | 2.0 | 2.0 |
| Citric acid | 0.7 | 0.7 |
| Sodium bicarbonate | 1.5 | 1.5 |

Analytical measurements are in the table below. The glass transition temperature was measured by differential scanning calorimetry (Mettler Toledo DSC3). Water activity was measured with a Decagon AquaLab 4TE.

| | | Creamer with | Reference |
|---|---|---|---|
| | | hydrolysed | creamer with |
| | | barley | glucose syrup. |
| Concentrate | Total solids (%) | 59.1 | 61.8 |
| | pH at 25° C. | 6.93 | 7.95 |
| Powder creamer | Moisture content (%) | 2.5 | 2.78 |
| | Water activity | 0.181 | 0.188 |
| | Glass transition | 64.03 | 65.93 |
| | temperature-onset Tg | | |
| | (° C.). | | |
| | Total fat (%) | 30.8 | 29.5 |

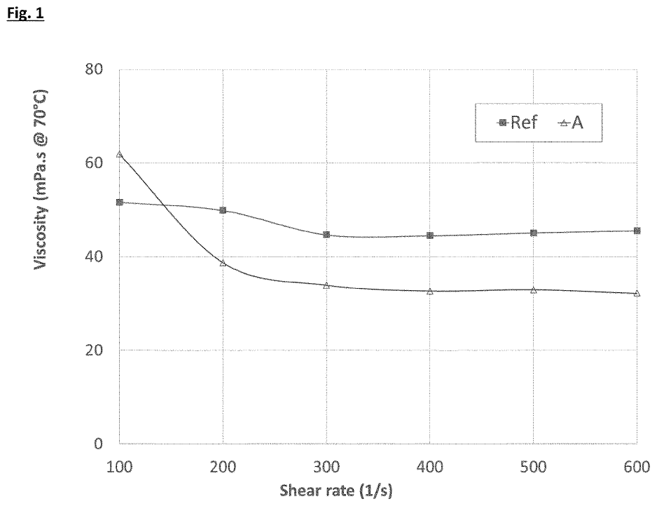

The creamer concentrates performed in a very similar way during processing and were found to have comparable viscosities (FIG. 1). Viscosity was measured with a Haake Rheostress 6000 instrument using with plate/plate geometry with a diameter of 60 mm and a measuring gap of 1 mm.

The product powder and reference powder were reconstituted and tested by a sensory panel and were found to have similar sweetness, taste and texture.

1. A creamer composition comprising;
10 to 55 wt. % of vegetable oil and/or milk fat;
0.1 to 4 wt. % of buffering agent;
15 to 70 wt. % of hydrolysed barley solids; and
the total amount of maltose is between 2% and 12% by weight of the creamer composition, and the total amount of maltotriose is between 2% and 12% by weight of the creamer composition,
all weight percentages being expressed on a dry basis.

2. The creamer composition of claim 1 further comprising 1 to 6 wt. % caseinate.

3. The creamer composition of claim 1 further comprising 15 to 30 wt. % non-fat milk solids.

4. The creamer composition of claim 1 further comprising 0.5 to 4 wt. % plant protein.

5. The creamer composition of claim 1 further comprising one or more emulsifiers.

6. The creamer composition of claim 1 wherein the creamer composition is in the form of a powder.

7. A method of producing a creamer composition comprising;
a) suspending barley in an aqueous liquid to produce a slurry;
b) hydrolysing the slurry of step a) with alpha-amylase;
c) removing particulates from the slurry after performing step b) to obtain a wort; and
d) combining the wort obtained in step c) with buffering agent, vegetable oil and/or milk fat to obtain a creamer.

8. The method of claim 7 wherein the hydrolysis in step b) is performed in the presence of one or more further enzymes selected from the group consisting of cellulase, xylanase, beta-glucanase, pullulanase, proteinase and lipase.

9. The method of claim 7 wherein transglucosidase is added to the hydrolysed slurry of step b) or the wort of step c) and allowed to act.

10. The method of claim 7 wherein a starch hydrolysate adjunct is added to the wort produced by step c).

11. The method of claim 10 wherein the starch hydrolysate adjunct is selected from the group consisting of hydrolysed tapioca, cassava, maize and rice.

12. The method of claim 10 wherein the starch hydrolysate adjunct is added to the wort at a ratio of between 1:0.4 to 1:2.5 adjunct to wort on a solids weight basis.

13. The method of claim 7 wherein the temperature of the slurry is increased to between 7° and 95° C. following step b) to inactivate the enzymes.

14. The method of claim 7 wherein the wort produced in step c) optionally containing starch hydrolysate adjunct, is evaporated to a total solids between 70% and 90% before being combined in step d).

15. The method of claim 7 wherein the wort and optional starch hydrolysate adjunct constitute between 15 and 70% by weight of the dry solids of the creamer obtained in step d).
